(19) United States
(12) Patent Application Publication
(10) Pub. No.: US 2003/0126506 A1
(43) Pub. Date: Jul. 3, 2003

(54) Program testing system and method

(76) Inventor: Frank Lin, Taipei (TW)

Correspondence Address: MARTINE & PENILLA, LLP, 710 LAKEWAY DRIVE, SUITE 170, SUNNYVALE, CA, 94085, US

(21) Appl. No.: 10/138,949

(22) Filed: May 3, 2002

(30) Foreign Application Priority Data
Dec. 31, 2001 (TW) 90133404

(51) Int. Cl. H02H 3/05; G06F 9/44

(52) U.S. Cl. 714/38; 717/124

(57) ABSTRACT

A program testing system includes an event list, a random selector, and a state machine. The event list records events that a to-be-tested program can handle. The random selector randomly selects the to-be-tested event from the event list. According to a current state and the contents of a state transition table of the to-be-tested program, the state machine determines whether the to-be-tested event is valid in relation to the current state. When the state machine determines that, in relation to the current state, the to-be-tested event is a valid event, the program testing system then based on this result uses a valid to-be-tested event to test the to-be-tested program. The present invention also discloses a program testing method for achieving the above-mentioned system.

### DESCRIPTION OF THE INVENTION

1. Field of the Invention

The present invention relates to a program testing system and method and, more specifically, to a program testing system and method which, according to its current state and a state transition table, generates a valid to-be-tested event.

2. Description of the Related Art

As information technology progresses, an information era and electronic era are rapidly expanding. Up until now, our daily life cannot escape from the information technology. Two key forces and foundations that promote and support the development of information technology are firstly the popularisation of the infrastructure of information and the increase of hardware capability; and secondly the development of software technology. The popularization of the infrastructure of information and the improvement in hardware capability further expand the application scopes and levels of information technology. It also increases the complexity of the application which then requires a subsequent increase in hardware size. And this forms the basis of technical development of software, which further fulfill the hope and ideals of each information technology user.

The main process for software development includes system analysis, system design, program design, testing and debugging, and the follow-up maintenance and updating. Each process is as crucial and significant as the others. Amongst these, the testing and debugging is very important task at the later stage for the software development process. Whether a program can be executed successfully or how well its efficiency is, depends not only on program design, but depends also on a testing method which can test, effectively and thoroughly, each individual event of each state of the program, to check whether the program runs as expected when it was designed to at the earlier stage of analyzing and designing, and correctly execute the operation for the user.

A conventional testing method that is widely used is “Force testing method”. The so called “Force testing method” is to randomly select an event and use random generator to generate any coordinate on the screen, and then sent the event and the coordinate to the to-be-tested program in order to test its processing capability. What it relies on is high performance hardware, in hope that through a massive testing, it can find any negligence in program design and coding. The defect of this kind of testing method is the strict requirement in hardware and the testing time required is longer. Besides, because the event is generated from a random number, there is no consistency relation among the type of events generated. For this, certain situation often cannot be tested. This is even more obvious when testing the human-machine interface program. As a result, the testing cannot meet the expectation desired, and the program tested still conceals many uncharted bugs.

Therefore, as mentioned above, how to test a program efficiently and systematically in hardware with general capability and yet still cover all situations that are possible to happen to effectively complete the testing is a problem that need to be solved urgently.

### SUMMARY OF THE INVENTION

In view of the above problems, an object of this invention is to provide a program testing system and method which, based on a current state and a state transition table, generates a valid to-be-tested event, in order to test the to-be-tested program.

In order to achieve the above-mentioned object, the program testing system of this invention includes primarily an event list, a random selector, and a state machine. The event list records events that the to-be-tested program can handle, and the random selector randomly selects the to-be-tested event from the event list. According to the current state and the contents of the state transition table of the to-be-tested program, the state machine determines whether the to-be-tested event is valid in relation to the current state. When the state machine determines that, in relating to the current state, the to-be-tested event is a valid event, the program testing system then, based on this result, uses a valid to-be-tested event to test the to-be-tested program.

The state transition table records how each pair of state and event should relate to. In one embodiment of this invention, if the to-be-tested event is a valid event in relation to the current state, according to the user interface in corresponding to the current state, a coordinate generator generates and outputs a coordinate required by the valid to-be-tested event. An event generator then, according to the coordinate, generates a valid to-be-tested event.

The state transition table can further record the next state for each current state. For this, according to the state transition table, the state machine can set the next state as the current state after the to-be-tested program completes the process with the valid to-be-tested event. In addition, the state machine can also update the new current state according to the processing result of the program executing the valid to-be-tested event.

In this invention, to judge whether the selected to-be-tested event is a valid event, the program testing system and the method use a current state and a state transition table. For this reason, all to-be-tested events actually been processed in the testing procedure are valid events. This reduces testing number of invalid events and as a result dramatically reduces the testing time required. Furthermore, because the system also references a state transition table for the testing, all valid events generated in sequence for the testing are related to one another. Therefore, the program can be tested efficiently and systematically, and thoroughly cover all possible events likely to happen for the test in order to complete the testing task effectively.

### BRIEF DESCRIPTION OF THE DRAWINGS

FIG. 1 is a structure chart illustrating the structure of the program testing system of an embodiment of the invention.

FIG. 2a is block diagram illustrating examples of user interfaces (states) and its contents of the embodiment of the invention.

FIG. 2b is a schematic diagram illustrating example fields and its contents in event list of the embodiment of the invention.

FIG. 3 is a schematic diagram illustrating example fields and its contents in the state transition table of the embodiment of the invention.

FIG. 4 is a block diagram illustrating the object coordinates in the example user interface of the embodiment of the invention.

FIG. 5 is a flow chart illustrating steps of program testing method in an embodiment of the invention.

### DETAILED DESCRIPTION OF PREFERRED EMBODIMENTS

With reference to related drawings, the following explains one program testing system and method according to the preferred embodiment of the invention, wherein same component will be illustrated with the same reference numeral for the description.

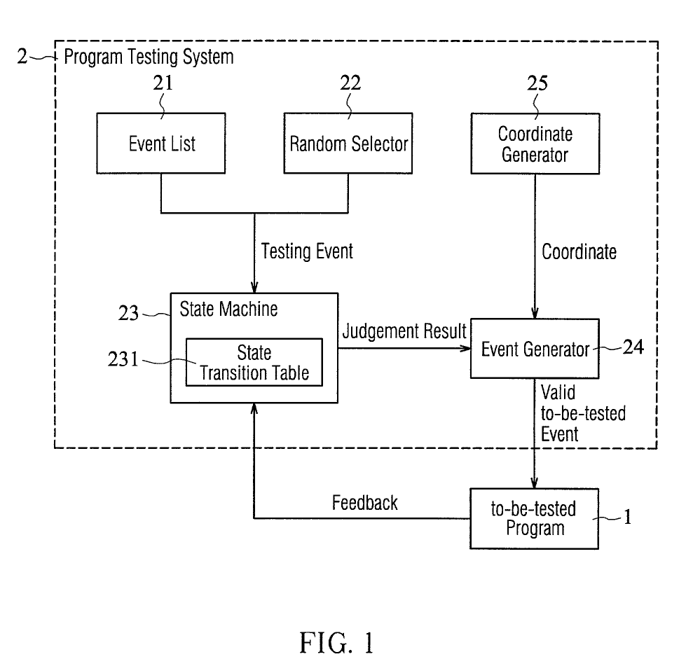

Referring to FIG. 1, as shown is the program testing system 2 of one embodiment of the invention. It tests a to-be-tested program 1. The to-be-tested program 1 comprises plurality of states and can process plurality of events. The program testing system 2 consists of an event list 21 which records events that the to-be-tested program is capable to process; a random selector 22 which randomly selects an event from the event list 21 for the testing; a state machine 23 which, according to a current state and a state transition table of the to-be-tested program, determines whether the to-be-tested event is a valid event in relation to the current state; and an event generator 24 which generates a valid to-be-tested event according to the judgment result from the state machine 23. Besides, the program testing system 2 further comprises a coordinate generator 25. According to a corresponding user interface, the coordinate generator 25 outputs a coordinate required for the generated valid to-be-tested event.

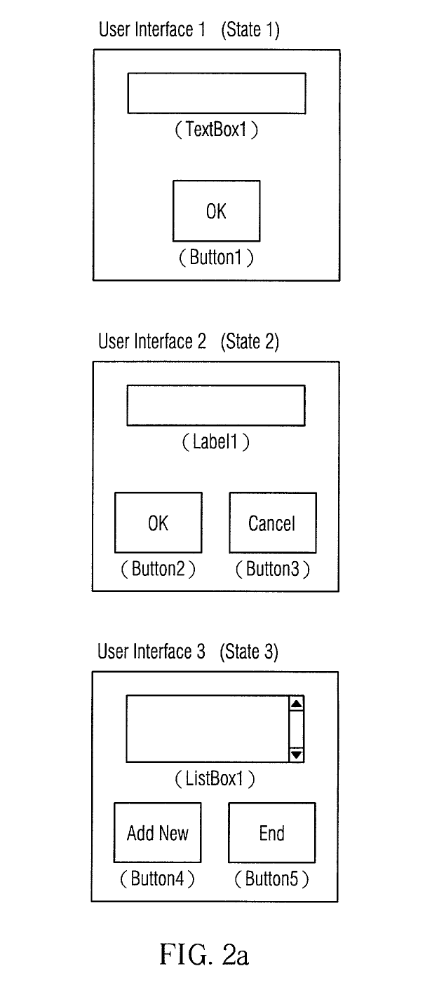

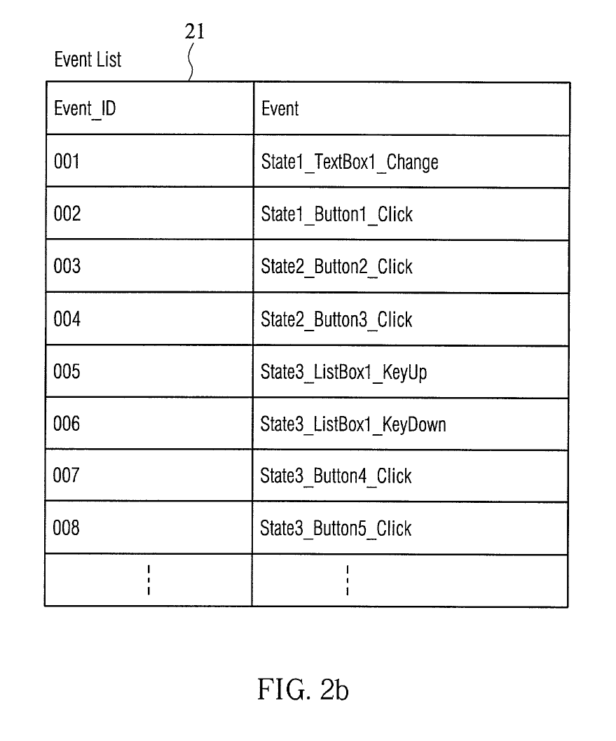

As shown in FIG. 2, State 1, State 2 and State 3 are three example states of the to-be-tested program 1. User interface 1, user interface 2, and user interface 3 are its corresponding display screens, respectively. Wherein, the user interface 1 comprises two objects which are TextBox1 and Button1. The user interface 2 comprises three objects which are Label1, Button2 and Button3. Similarly, user interface 3 comprises three objects which are ListBox1, Button4 and Button5.

Referring to FIG. 2b, the event list 21 consists of two columns which are Event_ID and Event, respectively. Wherein, event 001 is “State1_TextBox1_Change”, representing the content change in the TextBox1 of the user interface 1 that corresponding to the State 1. Event 002 is “State1_Button1_Click”, representing the click of Button1 in the user interface 1 corresponding to the State 1. Likewise, Event 003 “State2_Button2_Click” represents the click of Button2 in the user interface 2 corresponding to the State 2, Event 004 “State2_Button3_Click” represents the click of Button3 in the user interface 2 corresponding to the State 2, and so forth.

It should be noted that, in this embodiment, events of same kind working on different objects are considered as different events. As stated above, the same click button events working on different objects of different state, such as Button1 and Button2, are regarded as different events with different Event_ID 002 and 003. Even for working on different objects in the same state, such as Button2 and Button3, are also regarded as different events with different Event_ID 003 and 004. In addition, event list 21 in the FIG. 2b is only an example format. Any other formats or data structures that can record the to-be-tested program 1 can also apply this technique.

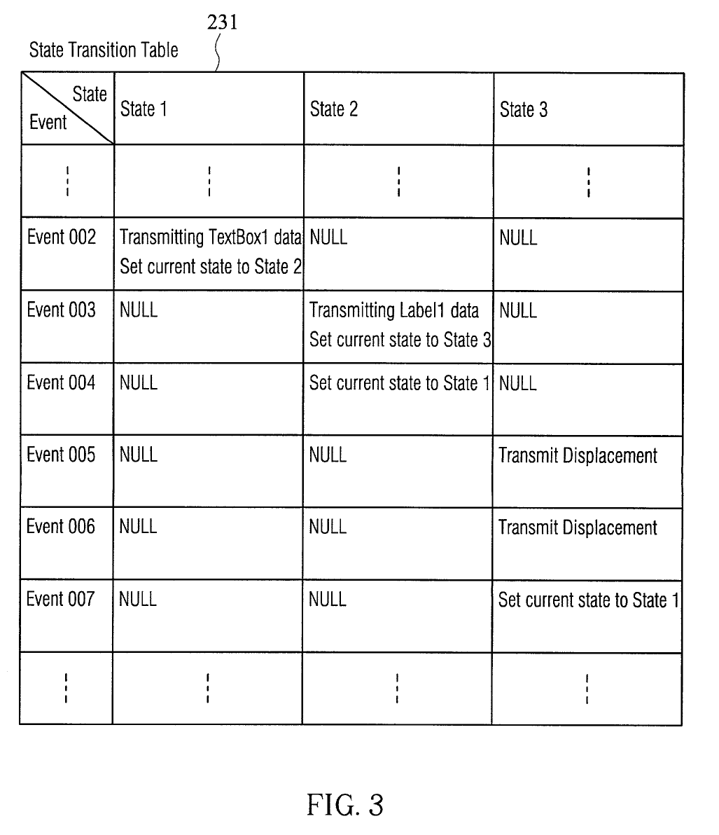

Referring to FIG. 3, a state transition table 231 records the corresponding relation between each state and each event. Take Event 002 as an example. When corresponds to State 1, it transmits the data of TextBox1 and alter the current state to State 2. When corresponds to State 2 or State 3, it contains a NULL value, namely, an invalid event. Aside from this, the corresponding relation of each state and each event can be just “Changing current state” as in Event 004 corresponding to State 2, or just “Executing certain action” as in Event 005 corresponding to State 3 and so forth.

It should be noted that, as mentioned above in the event list 21, state transition table 231 is also an example format only. Any other formats or data structures that can record the corresponding relation between each state and each event can also apply this technique.

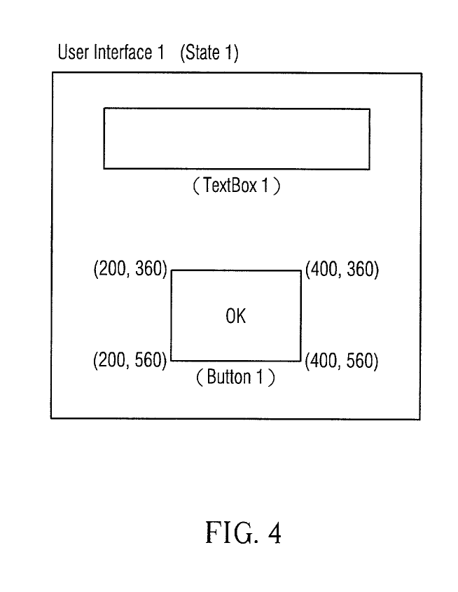

With reference to FIG. 1, when the above-mentioned event generator 24 generates a valid to-be-tested event according to the judgement result from the state machine 23, it still need to receive a coordinate output from the corresponding user interface of the current state in order to generate a valid to-be-tested event. With reference to FIG. 4, the coordinates of the four vertices of the Button1 in the user interface 1 in corresponding to the State 1 are (200, 360), (200, 560), (400, 360), and (400, 560), respectively. When the current state is State 1, to generate a valid event “Click Button1”, that is, the “State1_Button1_Click” event, according to the user interface 1, the coordinate generator 25 outputs a coordinate situated within (200, 360), (200, 560), (400, 360), and (400, 560) to the event generator 24, in order to generate a valid to-be-tested event.

For a better and easier understanding of this invention, a real example is used to illustrate the process of the program testing method for a preferred embodiment of this invention.

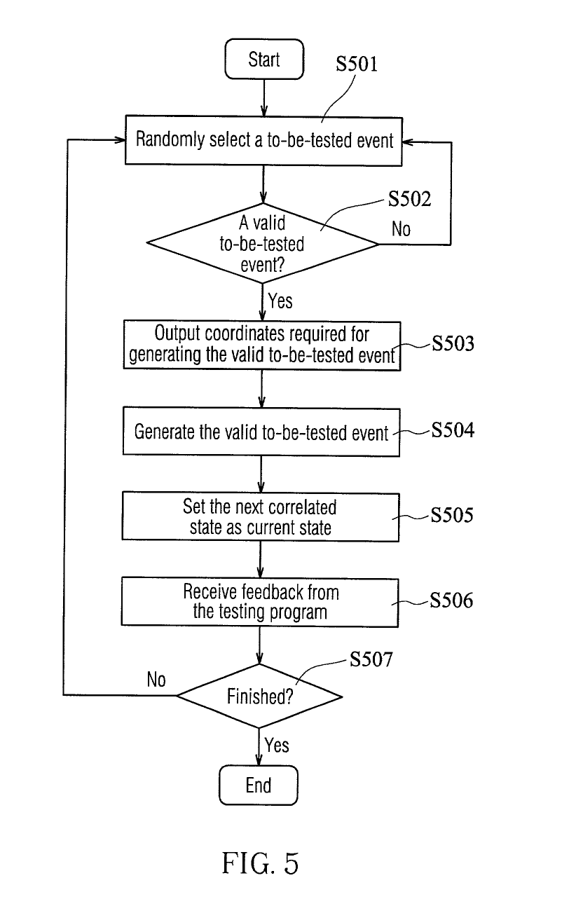

As shown in FIG. 5, the program testing method in the embodiment of the invention includes the following steps. First, an event is randomly selected from the event list 21 for testing (S501). Then, according to the current state and a state transition table 231 of the to-be-tested program 1, the state machine 23 determines whether the to-be-tested event is a valid one in relation to the current state (S502). If it is not, go back to S501 and randomly select a to-be-tested event again and determine its validity once more. If it is, according to the Unser Interface correlated to the current state, the coordinate generator 25 outputs a coordinate that is needed for producing a valid to-be-tested event (S503), and transmit it to the event generator 24 to generate a valid to-be-tested event (S504). At the meantime, if the data of corresponding relations recorded on the state transition table 231 includes a “Change current state”, the state machine 23 further, according to the recorded contents, sets the next state to be the current state in corresponding to the current state and the valid to-be-tested event (S505). After the to-be-tested program 1 completes executing the valid to-be-tested event, the state machine 23 receives a feedback from the to-be-tested program 1 (S506). In the case of the feedback includes information of “Change current state”, update the current state in accordance with the feedback contents. Lastly, check again if the testing proces is completed (S507). If not yet completed, loop back to S501 and follow the above steps to continue the testing; otherwise, finish the testing process.

To sum up, the program testing system and the method of this invention is to check whether the selected event is a valid to-be-tested event in accordance with the current state and the state transition table. Consequently, since all events that are actually been tested are valid events, it reduces the number of times and time required to test invalid events. Furthermore, as a result of the application of state transition table, the valid events generated before and after are all correlated. For this reason, the program testing system and the method of this invention can quickly and systematically test the to-be-tested program and thoroughly cover all events that are possible to happen, in order to complete the testing task effectively.

Note well that, anyone who are skilled in the above-mentioned technique can modify and alter the system and the method without deviating from the objects and scopes of the invention. For instance, the event list can directly store the coordinates for all valid events under each state. For this, it is no longer a requirment to refer to the corresponding user interface of the current state to output the coordinate needed for generating a valid to-be-tested event in order to get a valid event. However, the data size for such event list is relatively large. Any one who is skilled in the art can select any implementing method that fit into their circumstances and their actual needs.

Furthermore, in the above-mentioned embodiment, events of same type but working on different objects are considered as different events. However, if they are considered as the same, by effectively altering the data contents of the event list and the state transition table and to operate in coordination with the event generator, it can still produce valid events for the current state.

While the invention has been particularly described, in conjunction with specific preferred embodiments, it is evident that many alternatives, modifications and variations will be apparent to those skilled in the art in light of the foregoing description. It is therefore contemplated that the appended claims will embrace any such alternatives, modifications and variations as falling within the true scope and spirit of the invention.

What is claimed is:

1. A program testing system for testing a to-be-tested program that has a plurality of states and can process a plurality of events, the program testing system comprising:
an event list, which records all the events that the to-be-tested program is able to process;
a random selector, which randomly selects an to-be-tested event from the event list; and
a state machine which, according to a current state and a state transition table of the the to-be-tested program, determines whether the to-be-tested event is a valid event for the current state, wherein the state transition table records a correlated relation between each state and event and, when the state machine determines that the event is a valid event for the current state, the program testing system uses the judgement result to test the to-be-tested program as a valid to-be-tested event.

2. The program testing system as in claim 1, further comprising:
an event generator which, in accordance with the judgement result from the state machine, produces the valid to-be-tested event.

3. The program testing system as in claim 2, further comprising:
a coordinate generator which, in accordance with a unser interface correlated to the current state, outputs a coordinate that the event generator requires for producing the valid to-be-tested event.

4. The program testing system as in claim 1, wherein the correlated relation further comprises a next state, and the next state is one of the plurality of states.

5. The program testing system as in claim 4, wherein the state machine further sets the next state correlated to the state transition table as the current state in accordance with the current state and the valid to-be-tested event,.

6. The program testing system as in claim 1, wherein the state machine further updates the current state in accordance with the result of the to-be-tested program executing the valid to-be-tested event.

7. A program testing method for testing a to-be-tested program that has a plurality of states and can process a plurality of events, the program testing method comprising:
selecting a to-be-tested event randomly from an event list that records the plurality of events;
according to a current state and a state transition table of the to-be-tested program, checking if the to-be-tested event is valid in regarding to the current state, wherein the state transition table records a correlated relation between each state and event; and
testing the to-be-tested program with a valid to-be-tested event in accordance with the judgement result of the state machine.

8. The program testing method as in claim 7, further comprising:
producing the valid to-be-tested event.

9. The program testing method as in claim 8, further comprising:
outputing a coordinate that is necessary for producing the valid to-be-tested event, in accordance with a user interface correlated to the current state.

10. The program testing method as in claim 7, wherein the correlated relation further includes a next state and the next state is one of the plurality of states.

11. The program testing method as in claim 10, further comprising:
setting the next state correlated to the current state in the state transition table as the current state in accordance with the current state and the valid to-be-tested event.

12. The program testing method as in claim 7, wherein the state machine further updates the current state in accordance with the result of the to-be-tested program executing the valid to-be-tested event.

13. A computer readable recording medium which records program codes that once a computer loades in will be able to execute the following procedures:
selecting a to-be-tested event randomly from an event list which records a plurality of events;
according to a current state and a state transition table of the to-be-tested program, checking if a to-be-tested event is valid in regarding to the current state, wherein the state transition table records a correlated relation between each state and event; and
testing the to-be-tested program with a valid to-be-tested event in accordance with the judgement result of the state machine.

14. The computer readable recording medium as in claim 13, further executing the following procedures after the computer loades in the program codes:
according to a user interface correlated to the current state, outputing a coordinate that is required in order to produce the valid to-be-tested event.

15. The computer readable recording medium as in claim 13, further executing the following procedures after the computer loades in the program codes:
according to the current state and the valid to-be-tested event, setting the next state correlated to the current state in the state transition table as the current state.

16. The computer readable recording medium as in claim 13, further executing the following procedures after the computer loades in the program codes:
according to the result of the to-be-tested program executing the valid to-be-tested event, updating the current state.
